(19) United States
(12) Patent Application Publication
(10) Pub. No.: US 2006/0169515 A1
(43) Pub. Date: Aug. 3, 2006

(54) Dual-chain transfer case

(75) Inventors: Peter J. Bellich, Utica, MI (US); Thomas J. Foster, Royal Oak, MI (US)

Correspondence Address: BorgWarner INC.;PATENT ADMINISTRATOR, 3850 HAMLIN ROAD, AUBURN HILL, MI, 48326-2872, US

(73) Assignee: BorgWarner Inc., Auburn Hills, MI (US)

(21) Appl. No.: 11/039,573

(22) Filed: Jan. 20, 2005

(51) Int. Cl. B60K 17/34

(52) U.S. Cl. 180/241; 74/11

(57) ABSTRACT

The present invention relates to a transfer case or gearbox used in a motor vehicle that is capable of transferring power to both the front and rear wheels of the vehicle. The transfer case uses two or more chains for transferring power the various outputs of the transfer case. The use of two or more chains allows the transfer case housing to be curved so that is can be positioned around other underbody components.

### FIELD OF THE INVENTION

The present invention relates to a transfer case arrangement for overcoming packaging constraints on an all-wheel drive vehicle.

### BACKGROUND OF THE INVENTION

Traditionally, four-wheel drive and all-wheel vehicles enable transfer of drive torque, produced by an engine and supplied through a gear reducing transmission to front and rear wheel assemblies. A transfer case is generally provided for enabling the split of drive torque between the front and rear wheel assemblies. The transfer case includes an input, operably connected to an output of the transmission, a first output shaft and a second output shaft, respectively connected with the wheel assemblies. A transfer mechanism is provided therein for selectively engaging the first and second output shafts, enabling the transfer of drive torque therebetween. The transfer case must be conveniently packaged within a vehicles underbody, avoiding interference with other vehicle components including drive shafts, exhaust systems, suspension, vehicle frame and the like. Packaging of the transfer case within a vehicle underbody has become more difficult in recent years as automakers seek to implement four-wheel and all-wheel drive systems in smaller vehicle applications. In view of the above, it is desirable in the industry to provide an improved transfer case design that overcomes packaging constraint issues.

### SUMMARY OF THE INVENTION

The present invention relates to a transfer case or gearbox used in a motor vehicle that is capable of transferring power to both the front and rear wheels of the vehicle. An input shaft is coupled to a source of power on one end, such as a transmission and extends into the housing of the gearbox. A first output shaft is operably connected to one or more of the rear wheels of the vehicle. The first output shaft is driven by the input shaft. A second output shaft is connected to one or more of the front wheels of the vehicle and is also driven by the input shaft. Two or more linkage assemblies are connected between the first output shaft and the second output shaft in order to transfer power between the first and second output shafts. The two or more linkage assemblies allow for the first and second output shafts to be positioned in different planes with respect to one another in order to provide a gearbox that will overcome some of the packaging limitations present in certain vehicle applications.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a plan view of the undercarriage of a motor vehicle incorporating the present invention;

FIG. 2 shows a front cross-section plan view of the present invention demonstrating the possible positioning of the various components, and how interference with other vehicle components is avoided; and

FIG. 3 is side-view cross-section plan view of the present invention, showing in detail the various shafts, sprockets, and linkage assemblies.

### DETAILED DESCRIPTION OF THE PREFERRED EMBODIMENTS

The following description of the preferred embodiment(s) is merely exemplary in nature and is in no way intended to limit the invention, its application, or uses.

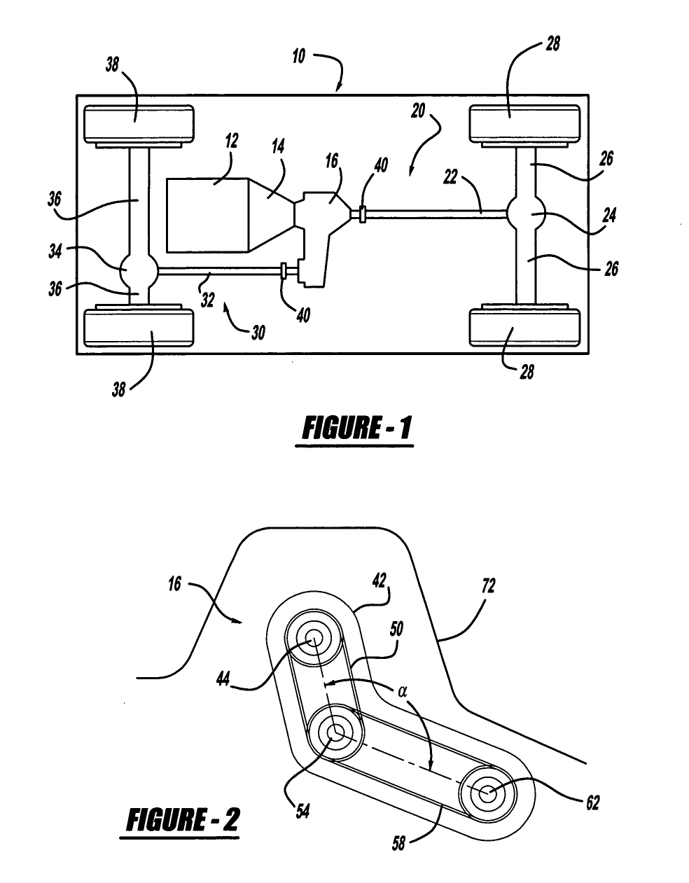

Referring to FIG. 1, an all-wheel vehicle drivetrain is diagrammatically illustrated as shown generally as 10. The all-wheel drivetrain 10 includes a prime mover 12 coupled to and driving a transmission 14. The transmission 14 can be an automatic or manual type transmission. The output of the transmission 14 drives a gearbox or transfer case assembly 16 that provides power to a primary or rear drive line 20, including a primary or rear output shaft 22, a primary or rear differential 24, a pair of live primary or rear axles 26 and a respective pair of primary or rear tire wheel assemblies 28.

The transfer case assembly 16 also selectively provides power to a secondary or front driveline 30 including a secondary or front output shaft 32, a secondary or front differential assembly 34, a pair of secondary or front axles 36 and a respective pair of secondary or front tire wheel assemblies 38. The front tire wheel assemblies 38 can be directly coupled to the front axles 36. Both the primary driveline 20 and the secondary driveline 30 may include suitable and appropriately disposed universal joints 40 that function in a conventional fashion to allow static and dynamic offset and misalignments between the various shafts and components.

While disclosed herein as front and rear drivelines 20, 30 the invention disclosed and claimed may be readily utilized in transmissions and transfer cases wherein the primary driveline 20 is disposed at the front of the vehicle and the secondary driveline 30 is disposed at the rear of the vehicle. Specifically, in those vehicles wherein the front driveline is engaged in operating substantially all of the time, i.e., a front wheel drive vehicle.

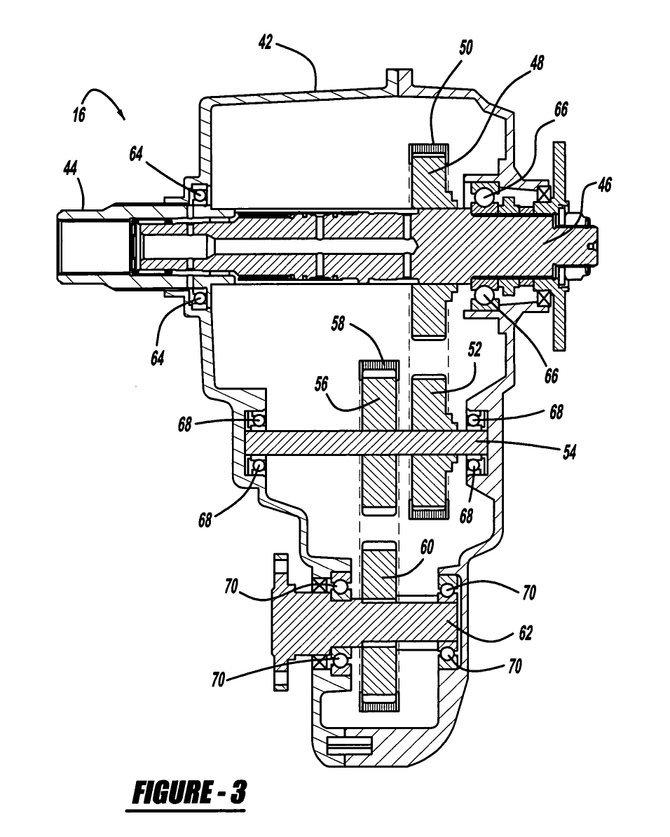

FIG. 3 depicts a cross-sectional plan view of the transfer case 16. The transfer case or gearbox has a housing 42 that rotatably receives an input shaft 44 from the transmission 14. The input shaft 44 is coupled to a first output shaft 46. The first output shaft 46 transmits power to one or more of the rear wheels 28 of the vehicle. The first output shaft 46 is coupled to the rear drive shaft 22 by the constant velocity joint 40. This allows power to transfer from the transfer case 16 to one or more the rear wheels 28 of the vehicle.

A sprocket 48 is connected to the first output shaft 46 and is configured to rotate with respect to the first output shaft 46. A first linkage assembly 50 is connected to the sprocket 48 and extends to a second sprocket 52 that is rotatably connected to an intermediate shaft 54 that is rotatably contained within the housing 42 of the transfer case 16. A third sprocket 56 is also rotatably connected to the intermediate shaft 54 and has a second linkage assembly 58 that extends to a fourth sprocket 60 that is rotatably connected to a second output shaft 62. The second output shaft 62 is connected via the constant velocity joint 40 to a front output shaft 32. This allows the second output shaft 62 to transfer power to one or more of the front wheels 38 of the vehicle. The linkage assemblies 50, 58 in a preferred embodiment of the invention are chains, however the linkage assembly can consist of other suitable components for transferring power such as belts or gears.

The transfer case 16 operates by having torque introduced to the housing 42 by the input shaft 44. The input shaft 44 is rotatably disposed on roller bearings 64. The first output shaft 46 is also rotatably connected to a pair of roller bearings 66. The first output shaft 46 is connectable or splined to the input shaft 44 so that when the input shaft 44 rotates the first output shaft 46 will also rotate. The sprocket 48 is connecting to the first output shaft 46 so that it will also rotate with the movement of the first output shaft 46. As the sprocket 48 rotates the first linkage assembly 50 will also rotate and cause torque to be transmitted to the intermediate shaft 54 through the sprocket 52. Bearings 68 allow rotation of the intermediate shaft 54. Two pairs of roller bearings 70 allow the second output shaft 62 to rotate freely in the housing. Although FIG. 2 only depicts sets of roller bearings 64, 66, 68, 70 it is within the scope of this invention to use a greater or lesser number of roller bearings depending on the type of transfer case being used. As the sprocket 52 rotates the intermediate shaft 54 will rotate and subsequently cause the third sprocket 56 to rotate.

As the third sprocket 56 rotates the second linkage assembly 58 will rotate and cause torque to be transmitted to the fourth sprocket 60. The fourth sprocket 60 is connected to the second output shaft 62 which transmit power to the front output shaft 32.

FIG. 2 depicts a cross-sectional schematic plan view of the transfer case and its orientation with respect to a vehicle floorboard 72. As shown in FIG. 2 the transfer case housing 42 is configured so that the input shaft 44 and the second output shaft 62 are not in the same plane. The use of two linkage assemblies 50, 58 allows for the transfer case 16 to have a modified shape so that it will fit neatly with the contours of the floorboard 72. The intermediate shaft 54 is used as a vertex of the angle a formed between the input shaft 44 and the front output shaft 62. It should be understood that the angle a can be greater or lesser depending upon the particular design requirements or angle of the floorboard 72. This allows the transfer case 16 to be neatly packaged within the vehicle underbody so that it will not interfere with other components of the vehicle. Additionally, it is possible to use more than two linkage assemblies in order to add additional shapes to the transfer case 16. For example, an alternate embodiment can include additional intermediate shafts and linkage assembly in order to give the transfer case 16 a general U-shape. It is also within the scope of the present invention to use even more intermediate shafts and linkage assemblies as desired or necessary, depending upon the design criteria of the vehicle underbody.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A gearbox for use in a vehicle that is capable of transferring power to both the front and rear wheels, comprising:
an input shaft coupled to a source of power;
a first output shaft connected to one or more wheels, said first output shaft being driven by said input shaft;
a second output shaft connected to one or more wheels, wherein said second output shaft is driven by said input shaft; and
two or more linkage assemblies disposed between and coupling said first output shaft to said second output shaft, wherein at least one of the linkages is selectively coupled to the second output shaft.

2. The device of claim 1, wherein said input shaft drives said one or more linkage assemblies, and transfers power to said second output shaft.

3. The device of claim 1, wherein said two or more linkage assemblies are located at a specified position relative to one another.

4. The device of claim 1, wherein said position of said two or more linkage assemblies can be changed to overcome packaging constraints underneath said motor vehicle.

5. The device of claim 1, wherein said input shaft and said secondary output shaft have sprockets operably disposed about their respective axis, capable of receiving said two or more linkage assemblies.

6. The device of claim 1, wherein said two or more linkage assemblies are coupled to one or more intermediate shafts.

7. The device of claim 6, wherein said one or more intermediate shafts each have at least two sprockets, for receiving said two or more linkage assemblies wherein said intermediate shaft is configured to transfer torque from said first output shaft to said second output shaft.

8. The device of claim 1, wherein said linkage assemblies can be comprised of belts or chains.

9. A gearbox for use in a motor vehicle, comprising:
an input shaft, having a first sprocket connected to and circumscribing said input shaft;
an intermediate shaft operably disposed in said gearbox, having a second sprocket and a third sprocket each connected to and circumscribing said intermediate shaft;
a first output shaft connected to one or more wheels, wherein said first output shaft is driven by said input shaft;
a second output shaft connected to one or more wheels, having a fourth sprocket connected to and circumscribing said second output shaft;
a first linkage assembly coupled between said first sprocket of said input shaft and said second sprocket of said intermediate shaft; and
a second linkage assembly coupled between said third sprocket of said intermediate shaft and said fourth sprocket of said secondary output shaft.

10. The gearbox of claim 9, where in said second output shaft is selectively driven by said input shaft.

11. The gearbox of claim 9, wherein said first linkage assembly, and said second linkage assembly are configured at an angle with respect to each other and said intermediate shaft serves as a vertex of the angle.

12. The gearbox of claim 9, wherein said angle created by said first linkage assembly and said second linkage assembly can be changed to be lesser or greater in order to overcome packaging constraints.

13. A method of overcoming packaging constraints when using a transfer case in a motor vehicle including an input shaft coupled to a source of power, a first output shaft connected to one or more wheels, a second output shaft connected to one or more wheels, two linkage assemblies disposed between and coupling said first output shaft to said second output shaft, wherein at least one of said two linkage assemblies is selectively coupled to the second output shaft, method comprising the steps of:
coupling the first of said two linkage assemblies to said input shaft;
coupling said two linkage assemblies to an intermediate shaft;
allowing for said two linkage assemblies and said intermediate shaft to be configured in more than one manner; and
driving said first output shaft and said second output shaft by said input shaft.

14. The method of claim 13, wherein said two linkage assemblies can be configured in such a way as to avoid interfering with other vehicle components.

15. The method of claim 13, wherein said two linkages are connected by said intermediate shaft.

16. The method of claim 13, wherein said input shaft, said first output shaft, and said second output shaft are circumscribed by and connected to sprockets that are capable of receiving said two linkage assemblies.

17. The method of claim 13, whereby power is transferred from said input shaft to said two linkage assemblies, thereby transferring power to said secondary output shaft.

18. The method of claim 13, wherein said two or more linkage assemblies can be comprised of belts or chains.
